(19) United States
(12) Patent Application Publication
(10) Pub. No.: US 2021/0012075 A1
(43) Pub. Date: Jan. 14, 2021

(54) METHOD FOR INTELLIGENT INSPECTIONS, ELECTRONIC DEVICE USING METHOD, AND NON-TRANSITORY STORAGE MEDIUM

(71) Applicants: HONGFUJIN PRECISION ELECTRONICES(YANTAI)CO.,LTD., Yantai (CN); HON HAI PRECISION INDUSTRY CO., LTD., New Taipei (TW)

(72) Inventors: FU-QIANG HE, Shenzhen (CN); KUNG-CHIEH CHENG, New Taipei (TW); YAN-LING PANG, Shenzhen (CN); NAN-NAN SONG, Yantai (CN)

(21) Appl. No.: 16/721,748

(22) Filed: Dec. 19, 2019

(30) Foreign Application Priority Data
Jul. 12, 2019 (CN) 201910631043.2

(51) Int. Cl. G06K 7/10; G06K 7/14; H04N 1/00

(52) U.S. Cl. CPC G06K 7/10722; H04B 1/38; H04N 1/00114; G06K 7/1417

(57) ABSTRACT

A method for intelligent inspections applicable in an electronic device scans a two-dimensional code, a scanned result including a first location information associated with the two-dimensional code. Next, the method for intelligent inspections transmits the scanned result to an inspection server to trigger the inspection server to return a command for a second location information of the electronic device. The second location information of the electronic device is given according to the command for the second location information of the electronic device. The second location information of the electronic device is transmitted to the inspection server. A related method for intelligent inspections applicable in an inspection server, and an electronic device using the method are also disclosed.

### FIELD

The subject matter herein generally relates to intelligent inspecting, and particularly, to a method for intelligent inspections, an electronic device, and a non-transitory storage medium.

### BACKGROUND

A conventional manual inspecting method requires inspection results to be recorded in writing by an inspector. The recorded content usually includes positions of pieces of equipment, places or stages in a process, inspection time, name of the inspector, and abnormalities discovered by the inspection. The conventional manual inspecting method may consume a lot paper, thus goals of energy saving and environmental protecting cannot be satisfied. In another aspect, since the conventional manual inspecting method uses paper to record the inspection results, the truth of the inspection results cannot be guaranteed. For example, whether the inspector inspects along a predetermined route cannot be verified. Moreover, a manager may not be familiar with the progress of the inspection. There is also a high possibility for loss or mishandling of the inspection result recorded on paper, and archiving and retrieval of the inspection result recorded on paper may require a lot of manpower and material.

### BRIEF DESCRIPTION OF THE DRAWINGS

Implementations of the present technology will now be described, by way of embodiments, with reference to the attached figures.

FIG. 1 illustrates a schematic view showing an embodiment of a system for intelligent inspections.

FIG. 2 illustrates a flowchart of an embodiment of a method for intelligent inspections applied on an electronic device of the system of FIG. 1.

FIG. 3 illustrates a flowchart of another embodiment of a method for intelligent inspections applied in an inspection server of the system of FIG. 1.

FIG. 4 illustrates a block view of an embodiment of an electronic device of the system of FIG. 1.

FIG. 5 illustrates a block view of an embodiment of an inspection server of the system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

In general, the word “module,” as used herein, refers to logic embodied in hardware or firmware, or to a collection of software instructions, written in a programming language. The software instructions in the modules can be embedded in firmware, such as in an erasable programmable read-only memory (EPROM) device. The modules described herein can be implemented as either software and/or hardware modules and can be stored in any type of computer-readable medium or other storage device.

The term “comprising” means “including, but not necessarily limited to”; it specifically indicates open-ended inclusion or membership in a so-described combination, group, series, and the like.

Embodiments of the present disclosure will be described with reference to the accompanying drawings.

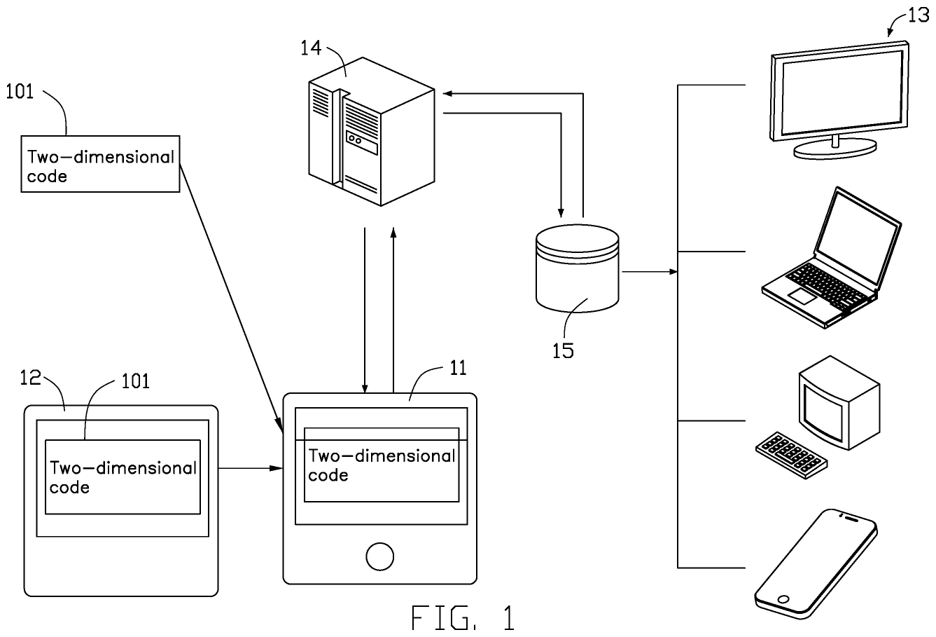

FIG. 1 illustrates a schematic view showing an embodiment of an intelligent inspecting system. The intelligent inspecting system can include at least one electronic device 11 and an inspection server 14. In the embodiment, one electronic device 11 is illustrated in the FIG. 1. It can be understood that, the number of the electronic devices 11 is not limited to one, the number of the electronic devices 11 can be two, three, or other. The electronic device 11 can communicate with the inspection server 14 via a wireless connection or by wires. The electronic device 11 can be a personal computer, a tablet computer, a mobile phone, a PDA, a wearable device, or the like. In the embodiment, four terminals are illustrated in FIG. 1. It can be understood that, the number of the terminals is not limited to four, the number of the terminals can be one, two, three, five, or other. The terminals can also communicate with the inspection server 14. Each of the terminal can be a personal computer, a tablet computer, a mobile phone, a PDA, a wearable device, or the like.

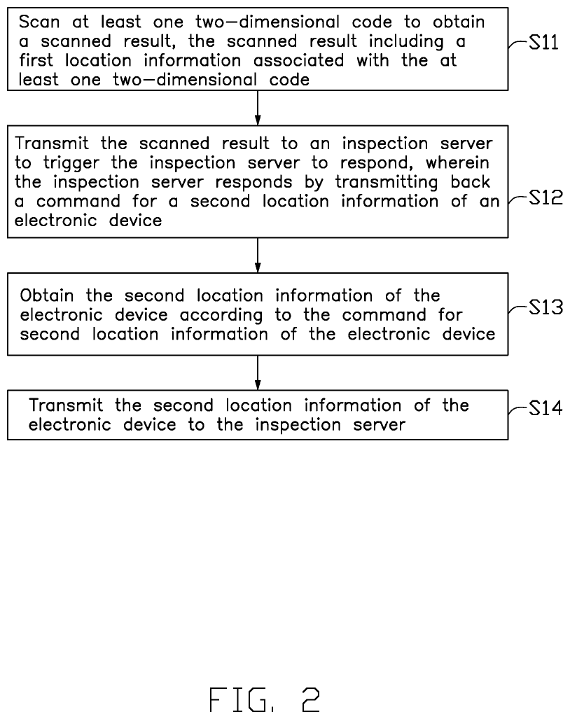

FIG. 2 illustrates a flowchart of an embodiment of a method for intelligent inspections applied on the electronic device. The illustrated order of blocks is illustrative only and the order of the blocks can be changed. The method for intelligent inspections of the FIG. 2 can begin at block S11.

At the block S11, at least one two-dimensional code is scanned to obtain a scanned result, the scanned result includes a first location information associated with the at least one two-dimensional code.

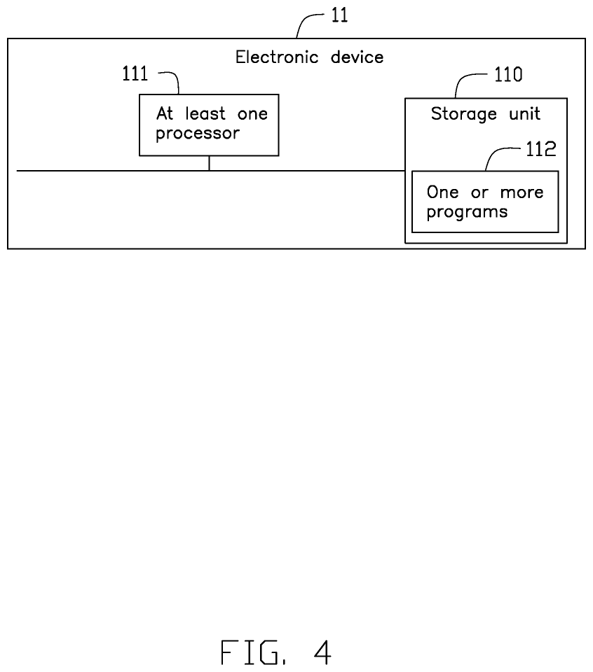

In the embodiment, referring also to the FIG. 1, the electronic device 11 scans at least one two-dimensional code 101 to obtain the scanned result. In the embodiment, a method used to scan the at least one two-dimensional code 101 to obtain the scanned result is according to an operation of selecting a scanning icon. In detail, the electronic device 11 includes a camera and at least one processor (shown in FIG. 4). The camera can be used to scan the at least one two-dimensional code 101 to form a two-dimensional code image. The at least one processor processes the two-dimensional code image to obtain the first location information associated with the at least one two-dimensional code 101. In the embodiment, the method further includes recording a time of a built-in clock of the electronic device 11 synchronously when scanning the at least one two-dimensional code 101.

In the embodiment, the at least one two-dimensional code 101 can include a two-dimensional code symbol with a fixed shape. The at least one two-dimensional code 101 can be a sticker, a coated pattern, or any other suitable fixed two-dimensional code symbols. Each of the at least one two-dimensional code 101 can store at least information of address of the at least one two-dimensional code 101 (hereinafter, the first location information), thus the first location information can be read from the at least one two-dimensional code 101 after the at least one two-dimensional code 101 is scanned. For example, a two-dimensional code XXX is arranged at a door A of the first warehouse, thus the two-dimensional code XXX stores at least information of address or location of the two-dimensional code XXX, namely, the door A of the first warehouse, thus the information read from the two-dimensional code XXX after the two-dimensional code XXX is scanned can include information of the door A of the first warehouse. Another two-dimensional code YYY is arranged at a door B of the second warehouse, thus the two-dimensional code YYY stores at least information of address or location of the two-dimensional code YYY, namely, the door B of the second warehouse, thus the information read from the two-dimensional code YYY after the two-dimensional code YYY is scanned can include information of the door B of the second warehouse.

In the embodiment, the at least one two-dimensional code 101 can include a two-dimensional code symbol with a changeable shape. This is, the two-dimensional code 101 is a changeable two-dimensional code. The at least one two-dimensional code 101 changes at time interval. The at least one two-dimensional code 101 after changing stores at least the first location information. In the embodiment, the changeable two-dimensional code 101 is displayed via an electrical two-dimensional code display 12. The electrical two-dimensional code display 12 stores a built-in two-dimensional code transform algorithm. The two-dimensional code transform algorithm randomly generates one two-dimensional code 101 according to certain characteristics. In detail, the electrical two-dimensional code display 12 can be coupled to the inspection server 14 via a network. The inspection server 14 transmits a reference value to the electric two-dimensional code display 12. The reference value includes at least one of a group consisting of figures, letters, and labels. The reference value received by the electrical two-dimensional code display 12 is changed at time intervals, for example, the reference value is changed at every twenty-four hours, or changed at every thirty seconds. Each of the electrical two-dimensional code display 12 can include a unique identity. The identities of the electrical two-dimensional code displays 12 are different. Thus, the certain characteristics include the first location information and at least one of a group consisting of the unique identity, the reference value, and a current time. The two-dimensional code transform algorithm operates the certain characteristics and converts the operated result of the characteristics to the at least one two-dimensional code 101.

In the embodiment, the method further includes providing a scanning shortcut for selecting, opening the camera of the electronic device 11, and entering into a two-dimensional code scanning interface. Through the two-dimensional code scanning interface, the at least one two-dimensional code 101 can be scanned by the camera.

In the embodiment, the scanning shortcut is arranged on a main interface. An inspector can select the scanning shortcut to request for opening the camera of the electronic device 11 and entering into the two-dimensional code scanning interface. The inspector can further operate the electronic device 11 to scan the at least one two-dimensional code 101.

In the embodiment, the method further includes providing a login interface for inputting a special account and a password for identification and authentication, and receiving an input account and password for identification.

In the embodiment, the inspector first inputs the special account and password in the login interface as identification and enters into the main interface after authentication. In the embodiment, the method further includes saving the inputted special account and password. In the embodiment, the special account and password are memorized for convenient login because of the method of the saving the inputted special account and password. The login interface can further include a version and an updating information for updating the version.

In the embodiment, the method further includes providing the main interface, including the scanning shortcut for selecting after the authentication is granted.

In the embodiment, the method further includes providing a working entrance interface, including selectable different departments to enter into the main interface corresponding to the department of the inspector after authentication is granted.

In the embodiment, the working entrance interface including selectable different departments is arranged between the login interface and the main interface. The selectable different departments in the working entrance interface can be named according to functions of the departments, for example, a first brigade patrol duty, a first brigade fixed duty, or the like. The working entrance interface can divide permission of entering into the main interface corresponding to the department according to the department of the inspector, thus the inspector can select to enter into the main interface corresponding to the department of the inspector.

At block S12, the scanned result is transmitted to the inspection server to trigger the inspection server to respond, wherein the inspection server responds by transmitting back a command for a second location information of the electronic device.

In the embodiment, the method can include simultaneously transmitting the scanned result and an image of an area of the scanned two-dimensional code 101 to the inspection server 14.

In the embodiment, the method can further include, simultaneously transmitting the scanned result, and an image of an area of the scanned two-dimensional code 101 with comments to the inspection server 14.

In the embodiment, the method further includes capturing the image of the area of the two-dimensional code 101 after scanning the at least one two-dimensional code 101. The image can be a photo or a video.

In the embodiment, the method further includes providing a comment interface for adding comments to the image of the area of the scanned two-dimensional code 101 after capturing the image of the area of the scanned two-dimensional code 101 to generate the image of the area of the scanned two-dimensional code 101 with comments to the image of the area of the scanned two-dimensional code 101. The comment can be a description or a label of the image, for example mentioning an abnormality found at the area of the scanned two-dimensional code 101, a suggestion to resolve the abnormality, or the like. In the embodiment, the comment can also include the image of the area of the scanned two-dimensional code 101 classified as being in order (normal) or otherwise.

In the embodiment, the method further includes organizing the images of the areas of the scanned two-dimensional codes 101 and/or images of the areas of the scanned two-dimensional codes with the comments to the images of the areas of the scanned two-dimensional codes 101 in a time sequence to form an inspection record.

In the embodiment, the method further includes displaying the inspection record.

In the embodiment, the method further includes simultaneously transmitting the two-dimensional code image or the characteristic of the two-dimensional code 101 to the inspection server 14 and transmit the scanned result to the inspection server 14.

In the embodiment, the method further includes transmitting the point in time when scanning the at least one two-dimensional code 101 to the inspection server 14.

At block S13, obtaining the second location information of the electronic device according to the command for second location information of the electronic device.

In the embodiment, the method can include opening a positioning device of the electronic device 11 after scanning the two-dimensional code 101, and obtaining the second location information of the electronic device 11 from the positioning device according to the command for a second location information of the electronic device 11. In the embodiment, the electronic device 11 can include the positioning device. The positioning device can self-locate as the second location information of the electronic device 11 when the two-dimensional code 101 is scanned. The method further includes obtaining the second location information of the electronic device 11 from the positioning device according to the command for the second location information of the electronic device 11.

In the embodiment, the positioning device can be set to be constantly open. For example, the positioning device is open when the electronic device 11 is started. The positioning device records the second location information of the electronic device 11. The method further includes obtaining the second location information of the electronic device 11 after the two-dimensional code 101 is scanned by the position device. For example, obtaining a position C, a position D, a position E, a position F, and a position G.

At block S14, the second location information of the electronic device is transmitted to the inspection server.

In the embodiment, the method can include transmitting the second location information of the electronic device to the inspection server 14 at intervals or continuously. That is, the method can include transmitting the second location information of the electronic device 11 to the inspection server 14 after the electronic device 11 obtains the instant second location information of the electronic device 11 when the two-dimensional code 101 is scanned. The method also can include transmitting the second location information of the electronic device 11 to the inspection server 14 after the electronic device 11 obtains the second location information of the electronic device 11 continuously after the two-dimensional code 101 is scanned. In the embodiment, the method further includes organizing the second location information of the electronic device 11 as a movement track of the electronic device, integrating the movement track into a built-in map to generate an inspection path, and displaying the inspection path. Thus, the method can record the inspection path of the inspector.

In the embodiment, the method further includes transmitting the inspection path being a map with the movement track of the electronic device to the inspection server 14.

In the embodiment, an inspecting application corresponding to the method for intelligent inspections is provided. In detail, the inspecting application can include the login interface. The inspector should first input the special account and password in the login interface for identification, and can enter into the main interface after authentication. The inputted special account and password in the login interface can be saved. Thus, the inspecting application can remember the special account and password for convenient login. The login interface can further include a version of the inspecting application. The login interface can also include an updating information for updating the version of the inspecting application in timely manner.

In the embodiment, the working entrance including different departments is arranged between the login interface and the main interface. The departments in the working entrance can be named according to the functions of the departments, for example, a first brigade patrol duty, a first brigade fixed duty, or the like. The working entrance can divide the permission of entering into the main interface corresponding to the department according to the department of the inspector, thus the inspector can select to enter into the main interface corresponding to the department of the inspector. Thus, the inspector can operate in the main interface.

In the embodiment, the main interface can include a scanning shortcut. The inspector can select the scanning shortcut to request for opening the camera of the electronic device 11 and entering into the two-dimensional code scanning interface. The inspector can further operate the electronic device 11 to scan the two-dimensional code 101. The inspecting application can further obtain the first location information stored in the two-dimensional code 101.

When an image of the area of the scanned two-dimensional code 101 is needed, the camera captures the image of the area of the scanned two-dimensional code 101 during inspecting after the two-dimensional code 101 is scanned. The image can be the photo or the video. After capturing the image of the area of the scanned two-dimensional code 101, the comment interface for adding comments to the image of the area of the scanned two-dimensional code is provided. In the comment interface, the comment (a description or label of the image), for example, describing an abnormality at the area of the scanned two-dimensional code 101, a suggestion to resolve the abnormality, or the like, can be added. In the embodiment, in the comment interface, the image of the area of the scanned two-dimensional code 101 can be classified as normal (all in order) or otherwise. The inspecting application organizes the images of the areas of the scanned two-dimensional codes 101 and the comment to each of the image of the area of the scanned two-dimensional codes 101 in a time sequence to form an inspection record. The inspection record can be displayed in the inspecting application.

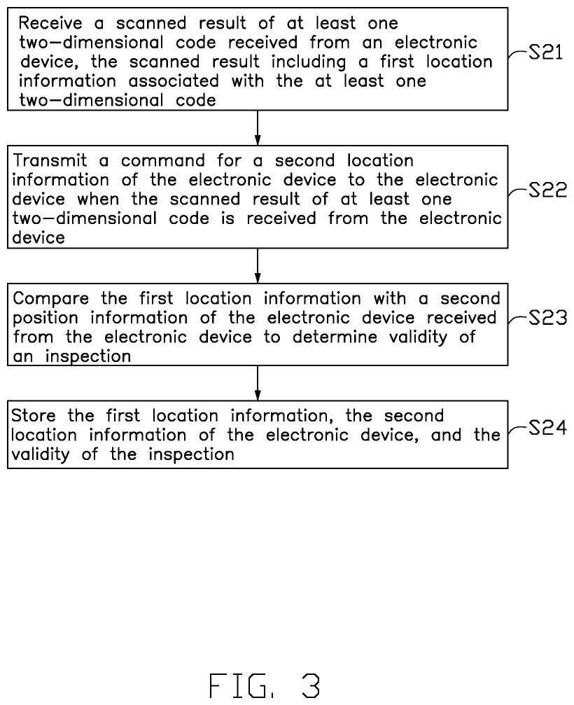

FIG. 3 illustrates a flowchart of an embodiment of another method for the intelligent inspection applied in the inspection server. The illustrated order of blocks is illustrative only and the order of the blocks can be changed. The intelligent inspection method of the FIG. 3 can begin at block S21.

At the block S21, a scanned result of at least one two-dimensional code from an electronic device is received, the scanned result includes a first location information associated with the at least one two-dimensional code.

Referring also to FIG. 1, in the embodiment, the inspection server 14 receives a scanned result of at least one two-dimensional code 101 from an electronic device 11.

In the embodiment, the at least one two-dimensional code 101 can include a two-dimensional code symbol with a fixed shape. The at least one two-dimensional code 101 can be a sticker, a pattern of coating, or any other suitable fixed two-dimensional code symbols. Each of the at least one two-dimensional code 101 can store at least information of address of the two-dimensional code 101, namely, the first location information, thus the first location information can be read from the at least one two-dimensional code 101 after the at least one two-dimensional code 101 is scanned. For example, a two-dimensional code X is arranged at a door A of the first warehouse, thus the two-dimensional code X stores at least information of address of the two-dimensional code X, namely, the door A of the first warehouse, thus the information read from the two-dimensional code X after the two-dimensional code X is scanned can include information of the door A of the first warehouse. Another two-dimensional code Y is arranged at a door B of the second warehouse, thus the two-dimensional code Y stores at least information of address or location of the two-dimensional code Y, namely, the door B of the second warehouse, thus the information read from the two-dimensional code Y after the two-dimensional code Y is scanned can include information of the door B of the second warehouse.

In the embodiment, the at least one two-dimensional code 101 can include a two-dimensional code symbol with a changeable shape. This is, the two-dimensional code 101 is a changeable two-dimensional code. The at least one two-dimensional code 101 changes at time intervals. The at least one two-dimensional code 101 after changing stores at least the first location information. In the embodiment, the changeable two-dimensional code 101 is displayed via an electrical two-dimensional code display 12. The electrical two-dimensional code display 12 stores a built-in two-dimensional code transform algorithm. The two-dimensional code transform algorithm randomly generates the two-dimensional code 101 according to characteristics. In detail, the electrical two-dimensional code display 12 can be coupled to the inspection server 14 via a network. The method further includes transmitting a reference value to the electric two-dimensional code display. The method further includes storing the reference value. The reference value includes at least one of a group consisting of figures, letters, and labels. The reference value received by the electrical two-dimensional code display 12 is changed at time intervals, for example, the reference value is changed at every twenty-four hours, or changed at every thirty seconds. Each of the electrical two-dimensional code display 12 can include a unique identity. The unique identities of the electrical two-dimensional code displays 12 are different. Thus, the certain characteristics include the first location information and at least one of a group consisting of the unique identity, the reference value, and a current time. The two-dimensional code transform algorithm operates the certain characteristics and converts the operated result of the characteristic to the at least one two-dimensional code 101.

In the embodiment, the method further includes simultaneously receiving the two-dimensional code image or the characteristics of the two-dimensional code 101 from the electronic device 11 and receiving the scanned result from the electronic device 11.

In the embodiment, the method further includes decoding the two-dimensional code image to obtain the characteristics of the two-dimensional code 101.

In the embodiment, the inspection server 14 stores the unique identity. The method further includes analyzing the characteristics of the two-dimensional code 101. For example, the characteristics of the two-dimensional code 101 include the first location information, the unique identity, the reference value, and the current time. The method further includes comparing the unique identity and the reference value with a stored unique identity and the stored reference value to determine a validity of the inspection, ie. that the inspection is actually taking place. In the embodiment, during the comparison, the method compares the unique identity with the stored unique identity to determine whether the unique identity matches with the stored unique identity. If the unique identity matches with the stored unique identity, the method compares the reference value with the stored reference value to determine whether the reference value matches with the stored reference value. The reference value is corresponding to the unique identity of the two-dimensional code 101. If the reference value matches with the stored reference value, the method determines that the inspection is valid. If the unique identity does not match with the stored unique identity, or the reference value does not match with the stored reference value, the method determines that the inspection is a sham or not real.

In the embodiment, the method can further include simultaneously receiving the scanned result and an image of an area of the scanned two-dimensional code 101 from the electronic device 11.

In the embodiment, the method can further include associating the scanned result with the image of the area of the scanned two-dimensional code 101.

In the embodiment, the method can further include simultaneously receiving the scanned result, and an image of an area of the scanned two-dimensional code 101 with comments or labels attached to the image of the area of the scanned two-dimensional code 101 from the electronic device 11.

In the embodiment, the method can further include associating the scanned result with the image of the area of the scanned two-dimensional code 101 with comments to the image of the area of the scanned two-dimensional code 101.

At block S22, a command for a second location information of the electronic device to the electronic device is transmitted when the scanned result of at least one two-dimensional code is received from the electronic device.

In the embodiment, the command for a second location information of the electronic device 11 can be the command for controlling the electronic device 11 to obtain the second location information of the electronic device 11 and returning the second location information of the electronic device 11 as a response.

At block S23, the first location information is compared with a second location information of the electronic device received from the electronic device to determine the validity of an inspection.

In the embodiment, before comparing the first location information with a second location information of the electronic device 11 received from the electronic device 11 to determine the validity of an inspection, the method includes

receiving the second location information of the electronic device 11 from the electronic device 11.

In the embodiment, before comparing the first location information with a second location information of the electronic device 11 received from the electronic device 11 to determine the validity of an inspection, the method includes:

continuously receiving the second location information of the electronic device 11 from the electronic device 11.

In the embodiment, comparing the first location information with a second location information of the electronic device received from the electronic device to determine the validity of the inspection includes:

comparing the first location information with a second location information of the electronic device 11 received from the electronic device 11;

determining whether the first location information is within a preset range of the second location information of the electronic device 11;

determining that the inspection is valid if the first location information is within the preset range of the second location information of the electronic device 11.

In the embodiment, comparing the first location information with a second location information of the electronic device received from the electronic device includes:

comparing the first location information with the second location information of the electronic device received immediately after transmitting a command for a second location information of the electronic device 11 to the electronic device 11 when the second location information of the electronic device 11 is a continuously-transmitted location information of the electronic device 11.

In the embodiment, the method further includes

determining that the inspection is not real when the first location information is not within the preset range of the second location information of the electronic device 11.

At block S24, the first location information, the second location information of the electronic device, and the validity of the inspection are stored.

In the embodiment, the intelligent inspecting system can further include a database 15. The database 15 can be in the inspection server 14, or it can be a third-party database. The database 15 communicates with the inspection server 14 via a wireless network or a wire network. In the embodiment, storing the first location information, the second location information, and the validity of the inspection includes loading the first location information, the second location information, and the validity of the inspection to the database 15.

In the embodiment, the method can further include receiving the point in time when scanning the at least one two-dimensional code 101 from the electronic device 11.

In the embodiment, the method can further include receiving the inspection path being a map with an inspection path of the electronic device from the electronic device 11.

In the embodiment, the method can further include loading at least one point in time when scanning the at least one two-dimensional code 101.

In the embodiment, the method can further include loading the inspection path to the database 15, and the inspection path is viewable through at least one terminal.

In the embodiment, the intelligent inspecting system can further include at least one terminal 13. The terminal 13 communicates with the database 15 via a wireless network or a wire network. The terminal 13 can upload the information from the database 15. For example, the terminal 13 can upload the first location information, the second location information, the validity of the inspection, the point in time when scanning the at last one two-dimensional code 101, and the inspection path from the database 15, to display. Thus, a manager can know the progress of the inspection. The feedback of the inspection can be improved.

FIG. 4 illustrates a block view of an embodiment of an electronic device.

The electronic device 11 can include a storage unit 110, at least one processor 111, and one or more programs 112 stored in the storage unit 110 and can be run on the at least one processor 111. The at least one processor 111 can execute the one or more programs 112 to accomplish the steps of the method for intelligent inspections applied on the electronic device.

The one or more programs 112 can be divided into one or more modules/units. The one or more modules/units can be stored in the storage unit 110 and executed by the at least one processor 111 to accomplish the object of the present disclosure. The one or more modules/units can be a series of program instruction segments which can perform specific functions, and the instruction segment is configured to describe the execution process of the one or more programs 112 in the electronic device 11.

The electronic device 11 can be any suitable electronic device, for example, a personal computer, a tablet computer, a mobile phone, a PDA, a wearable device, or the like. A person skilled in the art knows that the device in the FIG. 4 is only an example and is not to be considered as limiting of the electronic device 11. Other examples may include more or fewer parts than the diagram, or combine certain parts, or include different parts, such as the electronic device 11 can also include one or more input and output devices, one or more network access devices, and so on.

The at least one processor 111 can be one or more central processing units, or it can be one or more other universal processors, digital signal processors, application specific integrated circuits, field-programmable gate arrays, or other programmable logic devices, discrete gate or transistor logic, discrete hardware components, and so on. The at least one processor 111 can be a microprocessor or the at least one processor 111 can be any regular processor, or the like. The at least one processor 111 can be a control center of the electronic device 11, using a variety of interfaces and lines to connect various parts of the entire electronic device 11.

The storage unit 110 stores the one or more programs and/or the modules/units. The at least one processor 111 can run or execute the one or more programs and/or the modules/units stored in the storage unit 110, call out the data stored in the storage unit 110, and accomplish the various functions of the electronic device 11, for example, apply the methods hereinbefore described. The storage unit 110 may include a program area and a data area. The program area can store an operating system, and applications that are required for the at least one function, such as sound playback features, image playback functions, and so on. The data area can store data created according to the use of the electronic device 11, such as video data, audio data, and so on. In addition, the storage unit 110 can include non-transitory storage medium, such as hard disk, memory, plug-in hard disk, smart media card, secure digital, flash card, at least one disk storage device, flash memory, or other non-transitory storage medium.

If the integrated module/unit of the electronic device 11 is implemented in the form of or by means of a software functional unit and is an independent standalone product sold or used, all parts of the integrated module/unit of the electronic device 11 may be stored in a non-transitory computer-readable storage medium. The electronic device 11 can use one or more programs to control the related hardware to accomplish all parts of the methods of this disclosure. The one or more programs can be stored in a computer-readable storage medium. The one or more programs can be accomplish the blocks of the method when executing by the at least one processor. The one or more stored programs can include a program code. The program code can be in the form of source code, object code, executable code file, or in some intermediate form. The computer-readable storage medium may include any entity or device capable of recording and carrying the program codes, recording media, USB flash disk, mobile hard disk, disk, computer-readable storage medium, read-only memory, or the like.

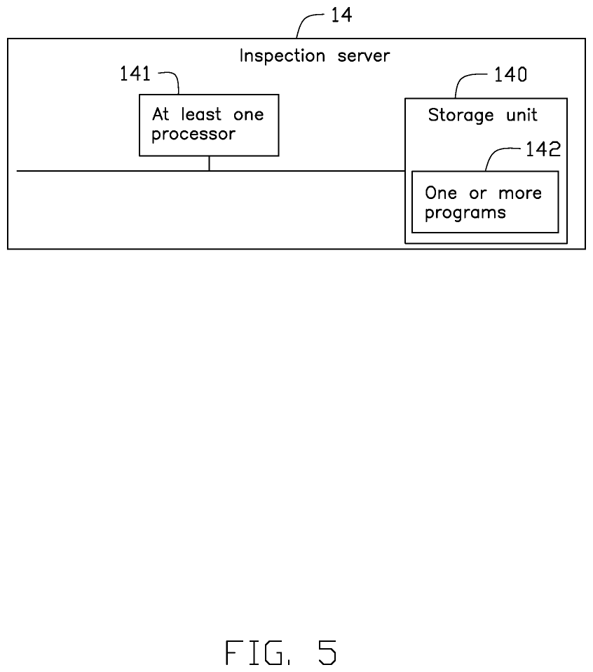

FIG. 5 illustrates a block view of an embodiment of an inspection server.

The inspection server 14 can include a storage unit 140, at least one processor 141, and one or more programs 142 stored in the storage unit 140 and can be run on the at least one processor 141. The at least one processor 141 can execute the one or more programs 142 to accomplish the steps of the method for intelligent inspections applied on the inspection server.

The one or more programs 142 can be divided into one or more modules/units. The one or more modules/units can be stored in the storage unit 140 and executed by the at least one processor 141 to accomplish the object of the present disclosure. The one or more modules/units can be a series of program instruction segments which can perform specific functions, and the instruction segment is configured to describe the execution process of the one or more programs 142 in the inspection server 14.

The inspection server 14 can be any suitable electronic device, for example, a personal computer, a tablet computer, a mobile phone, a PDA, a wearable device, or the like. A person skilled in the art knows that the device in the FIG. 5 is only an example and is not to be considered as limiting of the inspection server 14, other examples may include more or fewer parts than the diagram, or combine certain parts, or include different parts, such as the inspection server 14 can also include one or more input and output devices, one or more network access devices, and so on.

The at least one processor 141 can be one or more central processing units, or it can be one or more other universal processors, digital signal processors, application specific integrated circuits, field-programmable gate arrays, or other programmable logic devices, discrete gate or transistor logic, discrete hardware components, and so on. The at least one processor 141 can be a microprocessor or the at least one processor 141 can be any regular processor, or the like. The at least one processor 141 can be a control center of the inspection server 14, using a variety of interfaces and lines to connect various parts of the entire inspection server 14.

The storage unit 140 stores the one or more programs and/or the modules/units. The at least one processor 141 can run or execute the one or more programs and/or the modules/units stored in the storage unit 140, call out the data stored in the storage unit 140, and accomplish the various functions of the inspection server 14, for example, apply the methods hereinbefore described. The storage unit 140 may include a program area and a data area. The program area can store an operating system, and applications that are required for the at least one function, such as sound playback features, image playback functions, and so on. The data area can store data created according to the use of the inspection server 14, such as video data, audio data, and so on. In addition, the storage unit 140 can include non-transitory storage medium, such as hard disk, memory, plug-in hard disk, smart media card, secure digital, flash card, at least one disk storage device, flash memory, or other non-transitory storage medium.

If the integrated module/unit of the inspection server 14 is implemented in the form of or by means of a software functional unit and is an independent standalone product sold or used, all parts of the integrated module/unit of the inspection server 14 may be stored in a non-transitory computer-readable storage medium. The inspection server 14 can use one or more programs to control the related hardware to accomplish all parts of the methods of this disclosure. The one or more programs can be stored in a computer-readable storage medium. The one or more programs can accomplish the blocks of the method when executing by the at least one processor. The one or more stored programs can include program code. The program code can be in the form of source code, object code, executable code file, or in some intermediate form. The computer-readable storage medium may include any entity or device capable of recording and carrying the program codes, recording media, USB flash disk, mobile hard disk, disk, computer-readable storage medium, read-only memory, or the like.

In the present disclosure, it should be understood that the disclosed methods and electronic devices can be employed or achieved in other ways. The electronic device exemplified is only illustrative.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
a storage system;
at least one processor; and
the storage system storing one or more programs, which when executed by the at least one processor, causing the at least one processor to:
scan at least one two-dimensional code to obtain a scanned result, the scanned result comprising first location information associated with the at least one two-dimensional code;
transmit the scanned result to an inspection server to trigger the inspection server to respond, wherein the inspection server responds by transmitting back a command for a second location information of the electronic device;
obtain the second location information of the electronic device according to the command for second location information of the electronic device; and
transmit the second location information of the electronic device to the inspection server.

2. The electronic device as described in claim 1, further causing the at least one processor to:
capture an image of an area of the two-dimensional code after scanning the at least one two-dimensional code; and
simultaneously transmit the image of the area of the two-dimensional code to the inspection server and transmit the scanned result to the inspection server.

3. The electronic device as described in claim 2, further causing the at least one processor to:
provide a comment interface for adding comments to the image of the area of the two-dimensional code after capturing the image of the area of the two-dimensional code to generate an image of the area of the two-dimensional code with comments to the image; and
simultaneously transmit the image of the area of the two-dimensional code with comments to the inspection server and transmit the scanned result to the inspection server.

4. The electronic device as described in claim 3, further causing the at least one processor to:
organize images of the areas of the two-dimensional codes or images of the areas of the two-dimensional codes with the comments to the images in a time sequence to form an inspection record; and
display the inspection record.

5. The electronic device as described in claim 1, further causing the at least one processor to:
simultaneously transmit a two-dimensional code image or characteristics of the two-dimensional code to the inspection server and transmit the scanned result to the inspection server, the two-dimensional code image storing at least one of a group consisting of the unique identity, the reference value, and a current time, the characteristics of the two-dimensional code comprising at least one of a group consisting of the unique identity, the reference value, and a current time.

6. The electronic device as described in claim 1, further causing the at least one processor to:
organize the second location information of the electronic device to form a movement track;
integrate the movement track into a built-in map to generate an inspection path; and
display the inspection path.

7. A method for intelligent inspections, applicable in an electronic device with a storage system and at least one processor, comprising:
the at least one processor scanning at least one two-dimensional code to obtain a scanned result, the scanned result comprising a first location information associated with the at least one two-dimensional code;
the at least one processor transmitting the scanned result to an inspection server to trigger the inspection server to respond, wherein the inspection server responds by transmitting back a command for a second location information of the electronic device;
the at least one processor obtaining the second location information of the electronic device according to the command for second location information of the electronic device; and
the at least one processor transmitting the second location information of the electronic device to the inspection server.

8. The method for intelligent inspections as described in claim 7, further comprising:
the at least one processor capturing an image of an area of the two-dimensional code after scanning the at least one two-dimensional code; and
the at least one processor simultaneously transmitting the image of the area of the two-dimensional code to the inspection server and transmitting the scanned result to the inspection server.

9. The method for intelligent inspections as described in claim 8, further comprising:
the at least one processor providing a comment interface for adding comments to the image of the area of the two-dimensional code after capturing the image of the area of the two-dimensional code to generate an image of the area of the two-dimensional code with comments to the image; and
the at least one processor simultaneously transmitting the image of the area of the two-dimensional code with comments to the image to the inspection server and transmitting the scanned result to the inspection server.

10. The method for intelligent inspections as described in claim 9, further comprising:
the at least one processor organizing the images of the areas of the scanned two-dimensional codes or images of the areas of the scanned two-dimensional codes with the comments to the images in a time sequence to form an inspection record; and
the at least one processor displaying the inspection record.

11. The method for intelligent inspections as described in claim 7, further comprising:
the at least one processor simultaneously transmitting a two-dimensional code image or characteristics of the two-dimensional code to the inspection server and transmitting the scanned result to the inspection server, the two-dimensional code image storing at least one of a group consisting of the unique identity, the reference value, and a current time, the characteristics of the two-dimensional code comprising at least one of a group consisting of the unique identity, the reference value, and a current time.

12. The method for intelligent inspections as described in claim 7, further comprising:
the at least one processor organizing the second location information of the electronic device to form a movement track;
integrating the movement track into a built-in map to generate an inspection path; and
displaying the inspection path.

13. A method for intelligent inspections, applicable in an inspection server with a storage system, and at least one processor, comprising:
the at least one processor receiving a scanned result of at least one two-dimensional code from an electronic device, the scanned result comprising a first location information associated with the at least one two-dimensional code;
the at least one processor transmitting a command for a second location information of the electronic device to the electronic device when the scanned result of at least one two-dimensional code is received from the electronic device;
the at least one processor comparing the first location information with a second location information of the electronic device received from the electronic device to determine validity of an inspection; and
the at least one processor storing the first location information, the second location information of the electronic device, and the validity of the inspection.

14. The method for intelligent inspections as described in claim 13, further comprising:
the at least one processor receiving the scanned result and an image of an area of the two-dimensional code from the electronic device simultaneously; and
the at least one processor associating the scanned result with the image of the area of the scanned two-dimensional code.

15. The method for intelligent inspections as described in claim 13, further comprising:
the at least one processor receiving the scanned result, and an image of an area of the two-dimensional code with comments to the image from the electronic device simultaneously; and
the at least one processor associating the scanned result with the image of the area of the two-dimensional code.

16. The method for intelligent inspections as described in claim 13, further comprising:
the at least one processor simultaneously receiving two-dimensional code image comprising a unique identity and a reference value and receiving the scanned result from the electronic device;
the at least one processor comparing the unique identity and the reference value with a stored unique identity and a stored reference value to determine the validity of the inspection.

17. The method for intelligent inspections as described in claim 16, further comprising:
the at least one processor comparing the unique identity with the stored unique identity to determine whether the unique identity matches with the stored unique identity;
the at least one processor comparing the reference value with the stored reference value to determine whether the reference value matches with the stored reference value if the unique identity matches with the stored unique identity, the reference value being corresponding to the unique identity of the two-dimensional code image;
the at least one processor determining that the inspection is valid if the reference value matches with the stored reference value.

18. The method for intelligent inspections as described in claim 17, further comprising:
the at least one processor determining that the inspection is not valid if the unique identity does not match with the stored unique identity, or the reference value does not match with the stored reference value.

19. The method for intelligent inspections as described in claim 13, further comprising:
the at least one processor loading the first location information, the second location information of the electronic device, and the validity of the inspection to a database communicating with the inspection server.

20. The method for intelligent inspections as described in claim 19, further comprising:
the at least one processor receiving an inspection path being a map with an inspection path of the electronic device from the electronic device;
the at least one processor loading the inspection path to the database, and the inspection path is viewable through at least one terminal.
